(19) United States
(12) Patent Application Publication
(10) Pub. No.: US 2013/0078351 A1
(43) Pub. Date: Mar. 28, 2013

(54) COMPOUNDS AND METHODS FOR ENHANCING SALTY TASTE

(71) Applicant: Joseph G. Brand, Wayne, PA (US)

(72) Inventor: Joseph G. Brand, Wayne, PA (US)

(73) Assignee: Monell Chemical Senses Center, Philadelphia, PA (US)

(21) Appl. No.: 13/576,855

(22) PCT Filed: Feb. 3, 2011
(86) PCT No.: PCT/US11/23546

§ 371 Date: Oct. 9, 2012

Related U.S. Application Data
(60) Provisional application No. 61/301,419, filed on Feb. 4, 2010.

(51) Int. Cl. A23L 1/226

(52) U.S. Cl. CPC A23L 1/226
USPC 426/534

(57) ABSTRACT

The present invention is directed to compounds that increase the saltiness intensity of sodium chloride in human taste. Compositions and foods comprising these compounds are also described.

### CROSS-REFERENCE TO RELATED APPLICATIONS

This application claims the benefit of priority to U.S. Provisional Patent Application Ser. No. 61/301,419, filed Feb. 4, 2010, which is herein incorporated by reference in its entirety.

### TECHNICAL FIELD

The present invention is directed to compounds that increase the saltiness intensity of sodium chloride in human taste.

### BACKGROUND

There are five basic tastes: sweet, bitter, umami, sour, and salty. Salty taste is produced primarily by the presence of sodium ions, which are generally imparted to foodstuffs by the addition and/or presence of sodium chloride or other sodium salts. Sodium, in addition to producing a salty taste, also enhances the flavor of food. Consequently, prepared foods typically include high levels of sodium.

While sodium imparts desirable taste characteristics to foodstuffs, it is known that an excess of sodium in the diet can lead to health problems such as hypertension and cardiovascular disease. Indeed, at-risk populations are generally advised to restrict their dietary intake of sodium. Unfortunately, reducing the amount of sodium in foodstuffs generally results in a less palatable food product.

One method of reducing sodium content in a food or beverage is to replace the sodium with another salty tasting ion salt. Low-sodium “salt substitutes” have been developed which usually contain potassium salts. None of these products are true sodium salty taste substitutes because they lack an acceptable salty taste. Such “off-tastes” make compliance difficult. In addition, while use of these products could theoretically aid in the reduction of dietary sodium, there is a risk of hyperkalemia (elevated blood potassium) associated with the use of these products. Non-sodium salty taste substitutes are difficult to identify because the receptor for salty taste is likely a sodium-specific ion channel.

Another method of reducing sodium content would be to identify compounds that, while having no salty taste of their own, act on taste receptors to enhance the salty taste of sodium such that less sodium is required to maintain the saltiness intensity of the foodstuff. As such, compounds that increase the saltiness intensity of sodium, in particular sodium chloride, are needed.

### SUMMARY

The present invention is directed to methods of increasing the saltiness intensity of sodium, preferably in the form of sodium chloride, in foodstuffs by adding a compound of formula I, or a salt form thereof, to the foodstuff.

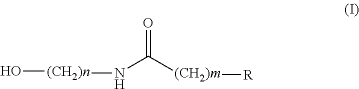

wherein
n is 1, 2, 3, 4, 5, or 6;
m is 1, 2, 3, 4, 5, or 6; and
R is C₁₋₁₀ straight-chain alkyl, C₁₋₁₀ branched alkyl, or guanidinium.

Compounds of formula I that increase the saltiness intensity of sodium, preferably in the form of sodium chloride, are also within the scope of the invention.

Also within the scope of the invention are compositions consisting of, or consisting essentially of, sodium, preferably in the form of sodium chloride, and a compound of formula I. Food products having an increased saltiness intensity comprising a foodstuff and a compound of formula I are also described. Methods of decreasing dietary sodium intake in a human are also described.

### BRIEF DESCRIPTION OF THE DRAWINGS

FIG. 1 is a histogram depicting the increase in saltiness intensity using a compound of the present invention.

FIG. 2 depicts the activity of N-(2-hydroxyethyl)-4-methylpentanamide (core compound) against an oocyte transfected with transcripts of the Epithelial Sodium Channel (ENaC) subunits delta/beta/gamma.

### DETAILED DESCRIPTION OF ILLUSTRATIVE EMBODIMENTS

It has now been discovered that compounds of formula I, or salt forms thereof:

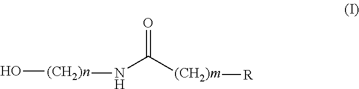

wherein
n is 1, 2, 3, 4, 5, or 6;
m is 1, 2, 3, 4, 5, or 6; and
R is C₁₋₁₀ straight-chain alkyl, C₁₋₁₀ branched alkyl, or guanidinium increase the saltiness intensity of sodium, in particular, sodium chloride, when added to foodstuffs. “Foodstuff,” as used herein, refers to any substance that can be used or prepared for use as a food that comprises sodium. The sodium, preferably in the form of sodium chloride, may be inherently present in the foodstuff or may be added to the foodstuff. If the sodium is added to the foodstuff, the sodium can be added prior to the addition of the compound of formula I, after the addition of the compound of formula I, about the same time as the addition of the compound of formula I, or at any time prior to the consumption of the foodstuff. Preferred foodstuffs of the invention include potato chips, tortilla chips, pretzels, popcorn, soups, ketchup, mustard, vegetables, fruits, chocolates, candy, frozen dinners, pizza, and the like.

Compounds of formula I have no or little salty taste on their own. Nevertheless, when combined with sodium, for example sodium chloride, the saltiness intensity of the sodium is markedly increased. Accordingly, less sodium is required to achieve a particular level of saltiness intensity in a foodstuff, which can lead to a reduction in dietary sodium

Preferred compound of formula I are those wherein n is 2. Other preferred compounds include those wherein m is 1, 2, 3, 4, or 5. In other preferred compounds, m is 1. In still other compounds, m is 2. In yet others, m is 3 or m is 4. In other embodiments, m is 5.

Preferably, compounds of formula I include those wherein R is C₁₋₁₀ straight-chain or C₁₋₁₀ branched alkyl. Preferred alkyl groups include methyl, ethyl, propyl, isopropyl, butyl, isobutyl, tert-butyl, pentyl, isopentyl, and hexyl. Preferably, R is propyl. More preferably, R is isopropyl. In other embodiments, R is guanidinium (—NH—C(═NH)—NH₂).

An example of a compound of formula I for use in the invention is N-(2-hydroxyethyl)-4-methylpentanamide:

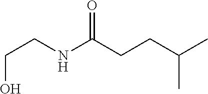

Other preferred compounds of formula I include

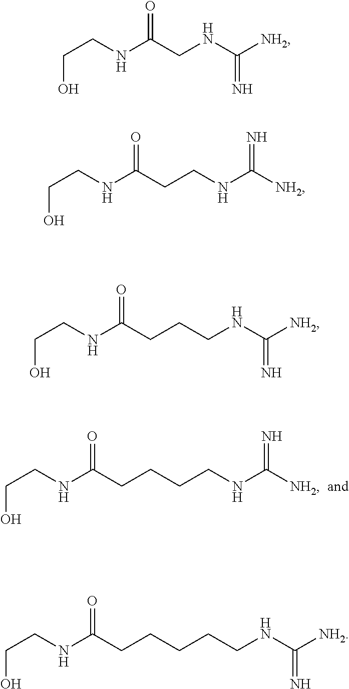

Food products having an increased saltiness intensity are also within the scope of the invention. Such food products comprise a foodstuff and a compound of formula I, wherein the compound of formula I is present in an amount sufficient to increase the saltiness intensity of sodium, preferably in the form of sodium chloride, in the foodstuff. The amount of the compound of formula I sufficient to increase the saltiness intensity of sodium in the foodstuff can be ascertained by one skilled in the art by reference to the examples set forth herein and by using routine experimentation. Such food products may inherently include sodium. Alternatively, sodium, preferably in the form of sodium chloride, can be added to the foodstuff prior to consumption of the food product.

It is well known that excess dietary sodium is a contributing factor in hypertension and heart disease and that at risk populations are encouraged to restrict their intake of dietary sodium. As the present invention increases the saltiness intensity of sodium, preferably in the form of sodium chloride, in foodstuffs, use of the invention can lead to the reduction of dietary sodium intake in a human as less sodium is required to achieve a particular level of saltiness intensity in the foodstuff. Consumption of food products of the invention comprising a foodstuff and a compound of formula I, in place of food products comprising a foodstuff not comprising a compound of formula I, would lead to a decrease in total intake of dietary sodium.

Also within the scope of the invention are compositions that comprise, consist of, or consist essentially of, sodium, preferably in the form of sodium chloride, and a compound of formula I. Such compositions may include, in addition to the sodium and the compound of formula I, other food additives. The addition of such additives can improve the handling or appearance of the composition, without materially affecting the basic and novel characteristics of the invention. Food additives are well-known in the art. For example, such compositions may include bulking agents, such as starch, that is added to a product to increase the bulk of the food without affecting nutritional value. Other additives include anticaking agents, antioxidants, and coloring.

Compounds of formula I can be prepared according to methods well-known to those skilled in the art. Preferred synthetic methods are set forth in Scheme 1.

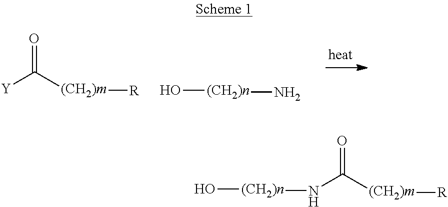

The present invention is not limited to the embodiments described and exemplified herein, but is capable of variation and modification within the scope of the appended claims.

### EXAMPLES

### Synthesis of N-(2-hydroxyethyl)-4-methylpentanamide

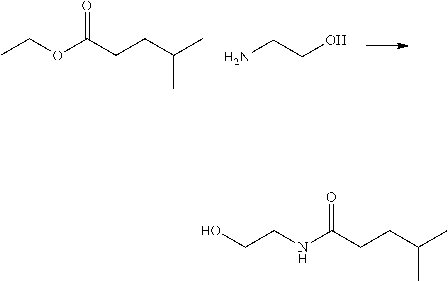

A reaction flask equipped with a magnetic stirrer bar, a nitrogen inlet and a simple distillation set-up was charged with ethyl 4-methylpentanoate (Sigma Aldrich, St. Louis, Mo.) (112.67 g, 781 mmol) and 2-aminoethanol (Sigma-Aldrich, St. Louis, Mo.) (73.38 g, 1201 mmol). The mixture was heated at reflux for 10.5 hours with concomminant removal of the ethanol formed during the reaction. After cooling to room temperature, the mixture was diluted with ethyl acetate (500 mL) and washed with 5% aqueous hydrochloric acid (3×200 mL). The combined aqueous layers were back-extracted with ethyl acetate (3×200 mL). The combined organic layers were washed with saturated aqueous sodium hydrogencarbonate (150 mL) and brine (100 mL), dried over anhydrous MgSO₄, and concentrated in vacuo. Vacuum distillation of the residue afforded the desired product in 42% yield and a purity >95% (bp 142° C./0.32 mbar). ¹H NMR (600 MHz, CDCl₃) δ0.87 (d, 6H, J=6.5 Hz)), 1.38-1.61 (m, 3H), 2.18 (dt, 2H, J=7.6 Hz, J=8.3 Hz), 3.36 (dt, 2H, J=5.5 Hz, J=5.5 Hz), 3.66 (t, 2H, J=5.2 Hz), 3.98 (br s, 1H), 6.60 (br s, 1H); ¹³C NMR (150 MHz, CDCl₃) δ22.4, 27.9, 34.8 (2x), 42.5, 62.0, 175.0.

Testing of N-(2-hydroxyethyl)-4-methylpentanamide in Oocytes

The frog, Xenopus laevis, produces oocytes that are particularly obliging in permitting a foreign gene to be incorporated into its protein translation system. The egg then makes this foreign protein encoded by the injected complimentary RNA (cRNA). Oocytes are harvested when at stage 5 or 6, from female Xenopus and defolliculated (using trypsin) and placed in low sodium culture medium. After overnight culture the egg is injected with the cRNA of the protein(s) of interest.

There is evidence that one of the major “receptors” of salty taste is the ENaC. This channel functions as a heterotrimer, a complex of three different peptides. The transfected eggs are then cultured for 4 to 6 days. Depending upon the endpoint of the study, all three subunits are expressed into one cell or one subunit is expressed per cell. The internal machinery of the cell places the ENaC into the plasma membrane. These preparations can be used as follows:
1. Two Electrode Voltage Clamp (TEVC) across the entire oocyte is the most direct method for detecting ion flux through the ENaC, but it will respond to any ion movement, making it less desirable for precise analyses, but very useful as an initial screen.
2. Patch clamp is used to record movement of very few ions through very few channels.

The approach manipulates a very small bore “patch pipette” to the oocyte membrane where it touches the membrane surface, and, when pulled away, brings along a “patch ” of the oocyte membrane now firmly held to the ring of the pipette. This method brings more precision, allows single channel responses to be seen, but the presence of other membrane proteins within the patch may modulate the response.

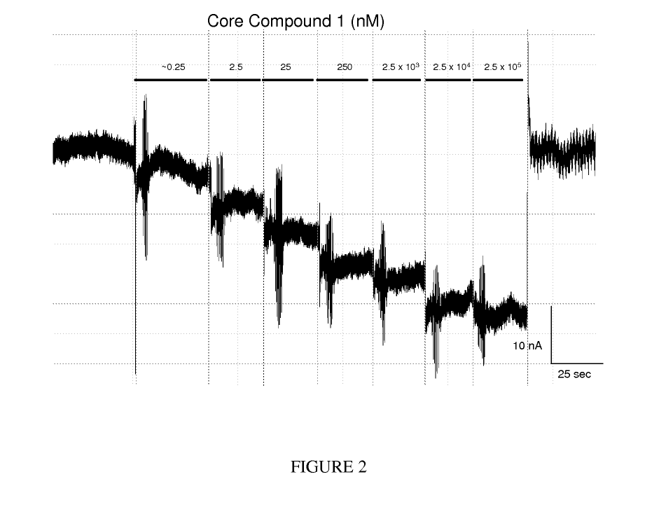

FIG. 2 shows the response of an oocyte expressing the delta, beta, gamma form of ENaC upon successive addition of increasing concentrations N-(2-hydroxyethyl)-4-methylpentanamide. The X axis is time, the Y-axis is inward current, the lower deflection indicating greater channel opening.

N-(2-hydroxyethyl)-4-methylpentanamide caused enhancement of sodium currents in oocytes (here using downward deflection to indicate channel opening) This inward current displayed high sensitivity (the values on the trace are in nanomolar) was completely reversible, and began from the baseline state (i.e., we did not need to partially inhibit the channel to see it open). These results suggested that 4-methyl-pentanoic acid (2-hydroxy-ethyl)-amide may act as an enhancer of salty taste.

Testing of N-(2-hydroxyethyl)-4-methylpentanamide in a Lipid Bilayer

One way to study only the ENaC with no interfering proteins from the oocytes or those of another cell line is to express each subunit as a protein out of a cell culture, and purify each subunit. The three subunits will be reconstituted to the desired ratio and blended into a lipid bilayer. An exemplary method is set forth in U.S. Publ. Appl. No. 2008-0108148, incorporated herein by reference.

Psychophysical Assessment of the Salty Taste Enhancing Properties of N-(2-hydroxyethyl)-4-methylpentanamide

121 subjects participated in this study. They were familiar with the taste of the 5 modalities (sweet, bitter, umami, sour, and salty), and the use of a modality—specific task. Each subject was presented with 5 cups, each having 10 ml of fluid, plus a large amount of water as a rinse before and in between each sampling. Subjects were told to hold the sample in their mouth for several seconds before making a judgment. Subjects sampled and rated all five solutions, then repeated the study. Subjects rated intensity and modality. The samples tested were
1. 50 mM NaCl
2. 75 mM NaCl
3. N-(2-hydroxyethyl)-4-methylpentanamide at 20 ppm
4. 50mM NaCl plus 20 ppm N-(2-hydroxyethyl)-4-methylpentanamide
5. 75 mM NaCl plus 20 ppm N-(2-hydroxyethyl)-4-methylpentanamide

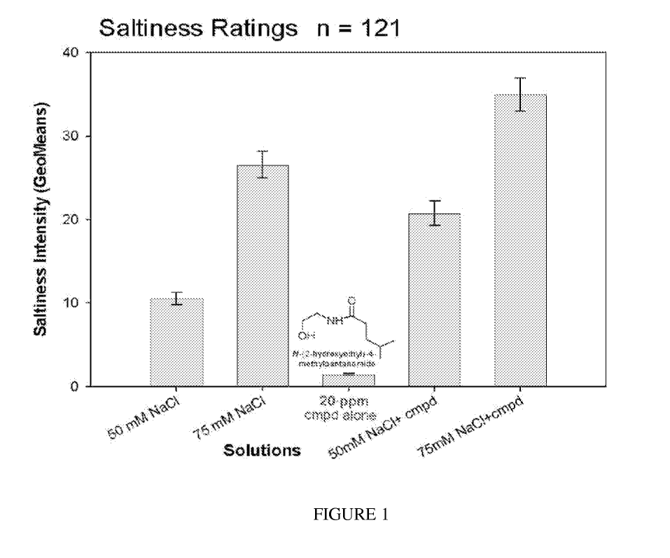

The results of this study are depicted in FIG. 1. The X-axis of FIG. 1 provides the identity of the five solutions that were rated and the Y-axis provides the Geometric Mean saltiness intensity ratings. Error bars are Geometric Standard Errors. N-(2-hydroxyethyl)-4-methylpentanamide has almost no saltiness of its own. It was slightly bitter tasting with an average bitterness intensity of 3 (data not shown). N-(2-hydroxyethyl)-4-methylpentanamide enhanced the saltiness of 50 mM NaCl by more than 100% and the saltiness of 75 mM NaCl by approximately 35%. Consistency among subjects was high as indicated by the error bars.

1. A method of increasing the saltiness intensity of sodium chloride in a foodstuff comprising:
adding a compound of formula (I), or a salt form thereof, to the foodstuff 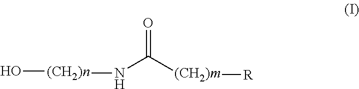
wherein
n is 1, 2, 3, 4, 5, or 6;
m is 1, 2, 3, 4, 5, or 6; and
R is C₁₋₁₀ straight-chain alkyl, C₁₋₁₀ branched alkyl, or guanidinium.

2. The method of claim 1, wherein n is 2.

3. The method of claim 1, wherein m is 1.

4. The method of claim 1, wherein m is 2.

5. The method of claim 1, wherein m is 3.

6. The method of claim 1, wherein m is 4.

7. The method of claim 1, wherein m is 5.

8. The method of claim 1, wherein R is propyl.

9. The method of claim 1, wherein R is isopropyl.

10. The method of claim 1, wherein R is guanidinium.

11. The method of claim 1, wherein the foodstuff inherently comprises sodium chloride.

12. The method of claim 1, wherein sodium chloride is added to the foodstuff before the addition of the compound of formula I.

13. The method of claim 1, wherein sodium chloride is added to the foodstuff after the addition of the compound of formula I.

14. The method of claim 1, wherein sodium chloride is added to the foodstuff prior to human consumption.

15. The method of claim 1, wherein the compound of formula I is:

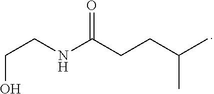

16. A composition consisting essentially of sodium chloride and a compound of formula I: 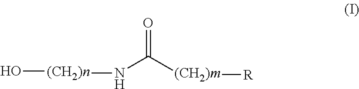
wherein
n is 1, 2, 3, 4, 5, or 6;
m is 1, 2, 3, 4, 5, or 6; and
R is C₁₋₁₀ straight-chain alkyl, C₁₋₁₀ branched alkyl, or guanidinium.

17. A food product having an increased saltiness intensity comprising
a foodstuff; and
a compound of formula I 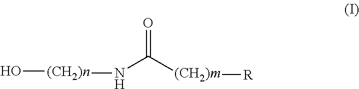
wherein
n is 1, 2, 3, 4, 5, or 6;
m is 1, 2, 3, 4, 5, or 6; and
R is C₁₋₁₀ straight-chain alkyl, C₁₋₁₀ branched alkyl, or guanidinium wherein the compound of formula I is present in an amount sufficient to increase the saltiness intensity of sodium chloride in the foodstuff

18. A method of reducing sodium intake in a human comprising: providing a foodstuff comprising a compound of formula I, or a salt form thereof: 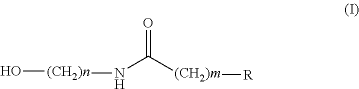
wherein
n is 1, 2, 3, 4, 5, or 6;
m is 1, 2, 3, 4, 5, or 6; and
R is C₁₋₁₀ straight-chain alkyl, C₁₋₁₀ branched alkyl, or guanidinium.

19. A compound of formula (I), or a salt form thereof 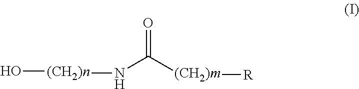
wherein
n is 1, 2, 3, 4, 5, or 6;
m is 1, 2, 3, 4, 5, or 6; and
R is C₁₋₁₀ straight-chain alkyl, C₁₋₁₀ branched alkyl, or guanidinium.
